(19) United States
(12) Patent Application Publication
(10) Pub. No.: US 2023/0259507 A1
(43) Pub. Date: Aug. 17, 2023

(54) SYSTEMS, METHODS, AND MEDIA FOR RETRIEVING AN ENTITY FROM A DATA TABLE USING SEMANTIC SEARCH

(71) Applicant: CAPRICORN HOLDINGS PTE. LTD., Singapore (SG)

(72) Inventors: Guillermo Infante, Singapore (SG); Abhishek Pradhan, Singapore (SG); Kok Zhao Jie, Singapore (SG); Selvarasu Anbarasan, Singapore (SG); Priyam Basu, New Delhi (IN)

(21) Appl. No.: 17/672,470

(22) Filed: Feb. 15, 2022

(51) Int. Cl. G06F 16/242; G06F 16/22; G06F 16/25

(52) U.S. Cl. CPC G06F 16/242; G06F 16/2282; G06F 16/258

(57) ABSTRACT

In accordance with some embodiments, systems, methods, and media for retrieving an entity from a data table using semantic search are provided. In some embodiments, a method of retrieving an entity from a data table is provided. The method includes receiving one or more files, and a query. The method includes linearizing a tabular set of data corresponding to the one or more files. The linearizing includes splitting the table into rows. The rows are stored in a data structure. The linearizing further includes splitting each of the rows into a respective sequence of cells. Each of the cells contain a value. The linearizing further includes converting each of the values into a corresponding string representation, and concatenating each of the string representations using the same sequence as that of the corresponding cells in the rows. The concatenated string representations for each row form a corresponding linearized row.

### BACKGROUND

Techniques for retrieving an entity from a data table may be useful for organizations to quickly receive information pertinent to decision making from a relatively large quantity of files.

### SUMMARY

In accordance with some embodiments of the disclosed subject matter, systems, methods, and media for retrieving an entity from a data table are provided.

In accordance with some embodiments of the disclosed subject matter, a method of retrieving an entity from a data table is provided. The method includes receiving one or more files, and a query. The method further includes linearizing a tabular set of data corresponding to the one or more file. The linearizing includes splitting the table into rows. The rows are stored in a data structure. The linearizing further includes splitting each of the rows into a respective sequence of cells. Each of the cells contain a value. The linearizing further includes converting each of the values into a corresponding string representation. The linearizing further includes concatenating each of the string representations using the same sequence as that of the corresponding cells in the rows. The concatenated string representations for each row form a corresponding linearized row. The method further includes generating a first set of vectors based on the linearized rows. The method further includes generating a query vector for the query. The method further includes outputting a result based on the first set of vectors and the query vector.

In some embodiments, the tabular set of data is identified using visual processing of the one or more files.

In some embodiments, the results is one or more of the linearized rows based on a distance between the query vector and one or more of the first set of vectors.

In some embodiments, the method further includes providing one or more prompts to identify a desired entity from the one or more output linearized rows, calculating a confidence score based on the one or more output linearized rows and the one or more prompts, comparing the confidence score to a confidence threshold, and if the confidence score is greater than the confidence threshold, outputting the entity.

In some embodiments, the method further includes presenting the outputted entity on a display.

In some embodiments, the query is a plurality of queries, the query vector is one of a plurality of query vectors, and the result is based on the first set of vectors and the plurality of query vectors.

In some embodiments, the one or more files are financial reports.

In some embodiments, the method further includes preprocessing the tabular set of data to remove non-alphanumeric characters, prior to linearizing the tabular set of data.

In accordance with some embodiments of the disclosed subject matter, a non-transitory computer readable medium is provided that stores programmable instructions that, when executed by a computing system, cause the computing system to receive one or more files, and a query. The programmable instructions, when executed by the computing system, further cause the computing system to linearize a tabular set of data corresponding to the one or more files. The linearizing includes splitting the table into rows. The rows are stored in a data structure. The linearizing further includes splitting each of the rows into a respective sequence of cells. Each of the cells contain a value. The linearizing further includes converting each of the values into a corresponding string representation. The linearizing further includes concatenating each of the string representations using the same sequence as that of the corresponding cells in the rows. The concatenated string representations for each rom form a corresponding linearized row. The programmable instructions, when executed by the computing system, further cause the computing system to generate first set of vectors based on the linearized rows, generate a query vector for the query, and identify an entity from the one or more files based on the first set of vectors and the query vector.

In some embodiments, the programmable instructions, when executed by the computing system, further cause the computing system to: provide one or more prompts to identify a desired entity from the one or more output linearized rows, calculate a confidence score based on the one or more output linearized rows and the one or more prompts, compare the confidence score to a confidence threshold, and if the confidence score is not greater than the confidence threshold, providing a message indicative of an invalid result.

In some embodiments, the programmable instructions, when executed by the computing system, further cause the computing system to: provide one or more prompts to identify a desired entity from the one or more output linearized rows, calculate a confidence score based on the one or more output linearized rows and the one or more prompts, compare the confidence score to a confidence threshold, and if the confidence score is greater than the confidence threshold, output the entity.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for retrieving an entity from a data table using semantic search in accordance with some embodiments of the disclosed subject matter.

FIG. 2 shows an example of hardware that can be used to implement a computing device and a server, shown in FIG. 1 in accordance with some embodiments of the disclosed subject matter.

FIG. 3 shows an example flowchart illustrating a process for retrieving an entity from a data table using semantic search in accordance with some embodiments of the disclosed subject matter.

FIG. 4 shows an example flowchart illustrating the table linearizing process of FIG. 3.

FIG. 5 shows an example flowchart illustrating the embedding generation process of FIG. 3.

FIG. 6 shows an example flowchart illustrating the semantic search process of FIG. 3.

FIG. 7 shows an example of a process for retrieving an entity from a data table using semantic search in accordance with some embodiments of the disclosed subject matter.

FIG. 8 shows an example of a process for linearizing a tabular set of data in accordance with some embodiments of the disclosed subject matter.

FIG. 9 shows an example of a process for calculating a confidence score in accordance with some embodiments of the disclosed subject matter.

### DETAILED DESCRIPTION

In accordance with various embodiments, mechanisms (which can, for example, include systems, methods, and media) for retrieving an entity from a data table using semantic search are provided.

As used herein, the term “entity” is any value (e.g., numeric value, string value, Boolean value, etc.) in a table that can be directly referred to through relevant header values (e.g., column titles, or row titles), or descriptions involving header values. For example, in a spreadsheet of financial data, a numeric value in a column labelled, “Profits” may be an entity. As another example, in a spreadsheet of personnel data, a string value in a column labelled, “Highest Grossing Employees” may be an entity.

As used herein, the term “query” is any text that provides information about a given entity. The query may or may not be phrased as a question. For example, the query “how much . . . ?” may indicate that the entity being searched for is a number value. Alternatively, or additionally, the query “who is . . . ?′ may indicate that the entity being searched for is a string value.

As used herein, the term “prompt” indicates any text (e.g., string value) provided to a Question Answering (QA) model with the intent of retrieving information from the model. For example, a query (defined above) may be received by a QA model and be referred to as a prompt. The query may or may not undergo a cleaning process prior to becoming the prompt.

As used herein, the term “Question Answering (QA) model” refers to a model capable of taking in a prompt. Given some contextual information regarding an entity to be searched, the QA model may produce a response to the prompt. The response may include the entity for which the prompt is searching.

As used herein, the term “linearization” refers to the process of breaking down a tabular data set into a collection of rows and converting each row into a text representation.

As used herein, the term “embeddings” or “embedding space” refers to any numeric dimensional space with points or regions capable of representing any abstract sources of information.

As used herein, the term “metric,” “similarity score,” or “similarity metric” refers to a numeric measure of similarity that can be applied to any pair of points in a given embedding space.

In the ordinary course of business, it may be necessary to review a relatively large number of documents in order to make necessary business decisions. For example, designated decision makers in corporations (e.g., managers, supervisors, executives) may need to review financial reports to determine where best to allocate, and how best to organize, resources (e.g., products, technology, funding, personnel, etc.). When reviewing the relatively large number of documents, it may be beneficial to use automated systems that review the documents and provide necessary details to the decisions makers. Use of automated systems may allow decision makers to make decisions relatively faster than if they were required to review each of the relatively large number of documents by hand. Further, use of automated systems may allow decision makers to make decisions that are relatively more accurate than if documents were reviewed by individuals prone to human error.

Semantic searching and natural language processing techniques may be useful for automated systems to utilize when reviewing documents (e.g., financial reports or personnel reports). Generally, semantic search techniques seek to allow computing devices to understand natural language in the same way that a human would understand the natural language. Semantic searching is a data searching technique in which a search query aims not only to find a desired entity, but also to determine the intent and contextual meaning behind the entity for which a user is searching to help provide valid results. More specifically, as described herein, semantic searching refers to the process of comparing points in an embedding space based on similarity metrics, as will be discussed further below.

Conventional methods for retrieving entities from data tables may require training machine-learning models with relatively large data sets. For example, a system (e.g., a processor on a computing device) may take as input a large pre-cleaned training dataset of financial reports, and generate a trained machine-learning model based on a pre-provided set of outputs corresponding to desired entities. The trained machine-learning model may then be applied to a second dataset of financial reports to produce an output of desired entities extracted from the second dataset. However, such conventional methods require a relatively high computational cost to both train the machine-learning model, and to analyze datasets using the trained machine-learning model.

Embodiments of the present disclosure may be useful to cure these and/or other deficiencies. For example, some embodiments of the present disclosure may linearize a tabular set of data to create string representations referred to as linearized rows. Embeddings or vectors may be generated based on the linearized rows. Further, a similarity metric may be used to identify relationships between the embeddings or vectors to output one or more desired entities from the tabular set of data. By using linearization and semantic searching, embodiments of the present disclosure may apply a zero-shot learning method to provided data sets (e.g., files or documents containing one or more sets of formatted data). Generally, zero-shot learning is a problem setup in machine learning where a method, algorithm, or model is applied to a data set on which it has not previously been trained. Since the mechanisms disclosed herein may not require training a machine-learning model, and instead may apply the zero-shot learning method, mechanisms disclosed herein may reduce computational costs significantly to retrieve one or more entities from a data table.

Furthermore, conventional methods that require machine-learning models to be trained on large sets of data may over-fit the trained machine-learning models to training data. Generally, when a model is over-fit to a set of training data, the model may provide results with relatively high accuracy when the model is provided with the training data. However, if the model is provided with data other than the training data, then the results may be relatively inaccurate. Mechanisms disclosed herein that rely on zero-shot learning can avoid over-fitting models to training data because there may be no training of a machine-learning model that occurs.

Some embodiments of the present disclosure may also provide greater security for private information. Conventional methods for retrieving an entity from a data table may require obtaining large data sets containing private information (e.g., confidential financial information, confidential personnel information, etc.) to train machine-learning models. Therefore, conventional methods may require relatively large quantities of private information to be transferred to individuals responsible for training machine learning models, to be transferred over servers, to be transferred on premise for an organization, or generally to be put at risk of interception or misuse. Comparatively, some embodiments of the present disclosure may not require datasets to train machine-learning models; therefore, mechanisms described herein may take as input only necessary information for retrieving one or more entities from a data table, without requiring further information (which may be private) to train a machine-learning model. By reducing or eliminating the necessity of large data sets (which may include private information) for training, it is easier to protect private information from interception or general misuse.

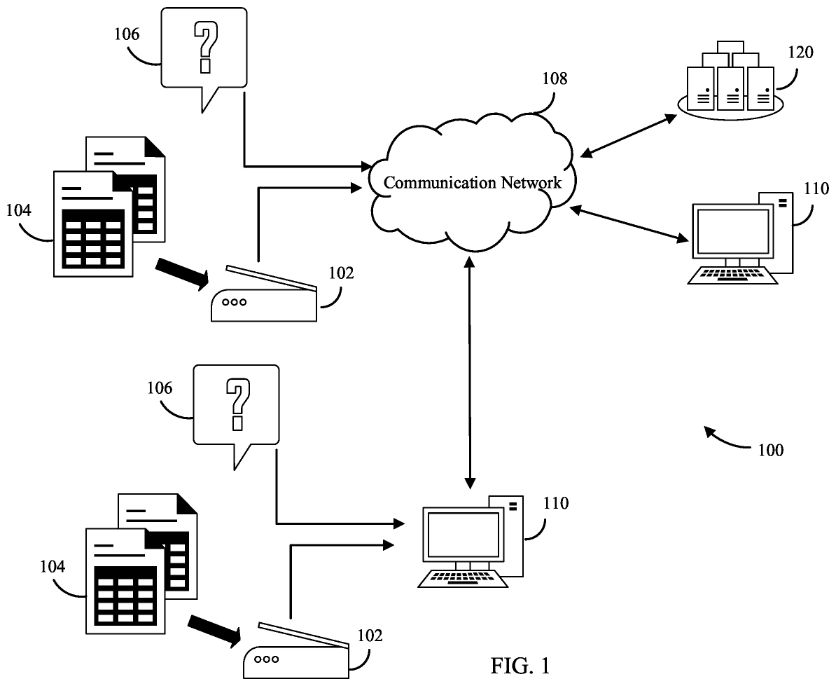

FIG. 1 shows an example of a system 100 for retrieving an entity from a data table using a semantic search in accordance with some embodiments of the disclosed subject matter. As shown in FIG. 1, the system 100 may include one or more visual processing devices or image capturing devices 102. The one or more image capturing devices or visual processing devices 102 may be scanners, cameras, or video equipment. The one or more visual processing devices 102 may receive (e.g., from a user) one or more data tables 104 and one or more queries 106. The system 100 may further include one or more computing devices 110, and one or more servers 120.

Still referring to FIG. 1, the one or more computing devices 110 can receive the one or more data tables 104 and the one or more queries 106. In some embodiments, the one or more computing devices 110 can execute at least a portion of the system 100 to retrieve an entity from a data table. For example, the computing device 110 can execute at least a portion of the system 100 to linearize a tabular set of data corresponding to the one or more files. The computing device 110 may additionally, or alternatively, execute at least a portion of the system 100 to split the table into rows, to store the rows into data structures, to split each of the rows into a respective sequence of cells, to store a value in each of the cells, to convert each of the values into a corresponding string representation, to concatenate each of the string representations using the same sequence as that of the corresponding cells in the rows, and/or to form a corresponding linearized row for each of the concatenated string representations.

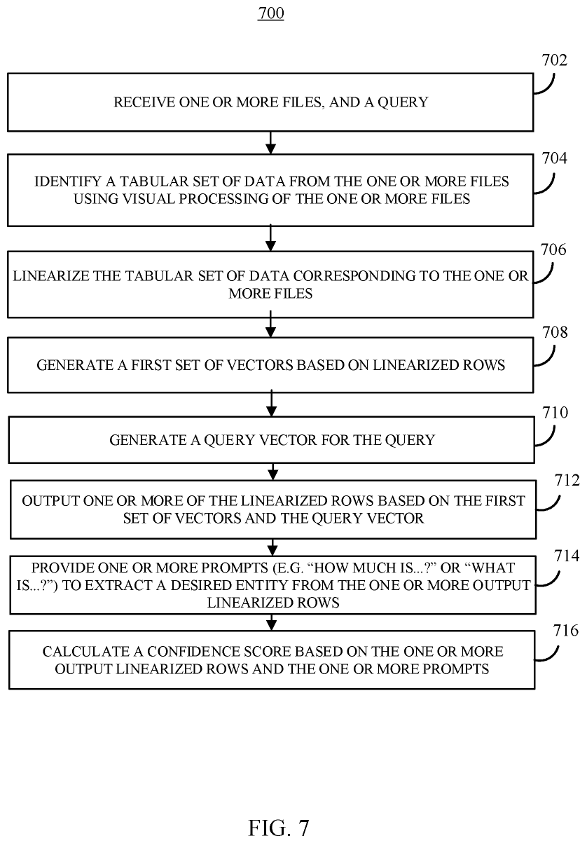

Additionally or alternatively, in some embodiments, computing device 110 can communicate data received from the one or more visual processing devices 102 to a server 120 over a communication network or connection 108. The server 120 can execute at least a portion of the system 100. In such embodiments, server 120 can return information to computing device 110 (and/or any other suitable computing device) indicative of an output of a process for retrieving an entity from a data table. In some embodiments, the system 100 can execute one or more portions of process 700 described below in connection with FIGS. 7-9.

The one or more data tables 104 may be disposed physically on files or documents (as shown in FIG. 1) and include information relevant to a decision maker in an organization. For example, the one or more data tables 104 may include financial data corresponding to profits, losses, gross margin, revenue, or any other financial values that can be referred to through relevant header values on the financial data tables, or descriptions involving header values on the financial data tables. Additionally, or alternatively, the data tables 104 may include personnel data corresponding to hours worked, name, supervisor, title, or any other values that can be referred to through relevant header values on the financial data tables, or descriptions involving header values on the financial data tables.

When the data tables 104 are disposed on physical files or documents, they may be extracted into a digital format, by way of the visual processing device 102. For example, a file containing the data table 104 may be scanned on the visual processing device 102 (e.g., a scanner). The scanned file may then be transmitted, transferred, or sent to a computing device 110 or remote server 120. The scanned file may be transmitted by way of the communication network 108.

The computing device 110 or server 120 may use visual processing (e.g., an artificially intelligent, or machine-learning algorithm) to identify the one or more data tables 104 from one or more files. Additionally, or alternatively, the visual processing device 102 may be configured to identify the one or more data tables 104 from a file and transfer only the data corresponding to the data tables 104 to the computing device 110 and/or server 120.

In some embodiments, the one or more files containing the one or more data tables 104 can be any suitable format of file data (e.g., a physical document, a comma separated value (CSV) file, a portable document format (PDF) file, a hypertext markup language file (HTML), a JavaScript object notation (JSON) file, Joint Photographic Experts Group (JPEG) file, etc.) and/or other file formats that can be used to extract an entity from a formatted set of data (e.g., a data table).

While the illustrated embodiment of FIG. 1 shows one or more physical documents containing data tables 104, it should be recognized that data tables 104 may be provided to the communication network 108, computing device 110, or server 120 in digital file data formats (e.g., one or more of the digital file formats discussed above). In this respect, a user may send a digital file containing one or more data tables 104 in an email, via a file sharing website, or via any other form of digital file transfer to the computing device 110 and/or server 120.

In some embodiments, computing device 110 and/or server 120 can be any suitable computing device or combination of devices, such as a desktop computer, a laptop computer, a smartphone, a tablet computer, a wearable computer, a server computer, a virtual machine being executed by a physical computing device, etc.

In some embodiments, the one or more data tables 104 can be local to computing device 110. For example, the one or more data tables can be incorporated with computing device 110 (e.g., computing device 110 can include memory that stores the one or more data tables 104, and/or can execute a program that generates the one or more data tables 104). As another example, the one or more data tables 104 can be uploaded to computing device 110 by a cable, a direct wireless link, etc. Additionally or alternatively, in some embodiments, the one or more data tables 104 can be located locally and/or remotely from computing device 110, and data can be communicated from the data tables 104 to computing device 110 (and/or server 120) via a communication network (e.g., communication network 108).

In some embodiments, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 108 can be a local area network (LAN), a wide area network (WAN), a public network (e.g., the Internet), a private or semi-private network (e.g., a corporate or university intranet), any other suitable type of network, or any suitable combination of networks. Communications links shown in FIG. 1 (e.g., the arrow between the server 120 and the communication network 108, and the arrow between the visual processing device 102 and the communication network 108) can each be any suitable communications link or combination of communications links, such as wired links, fiber optic links, Wi-Fi links, Bluetooth links, cellular links, etc.

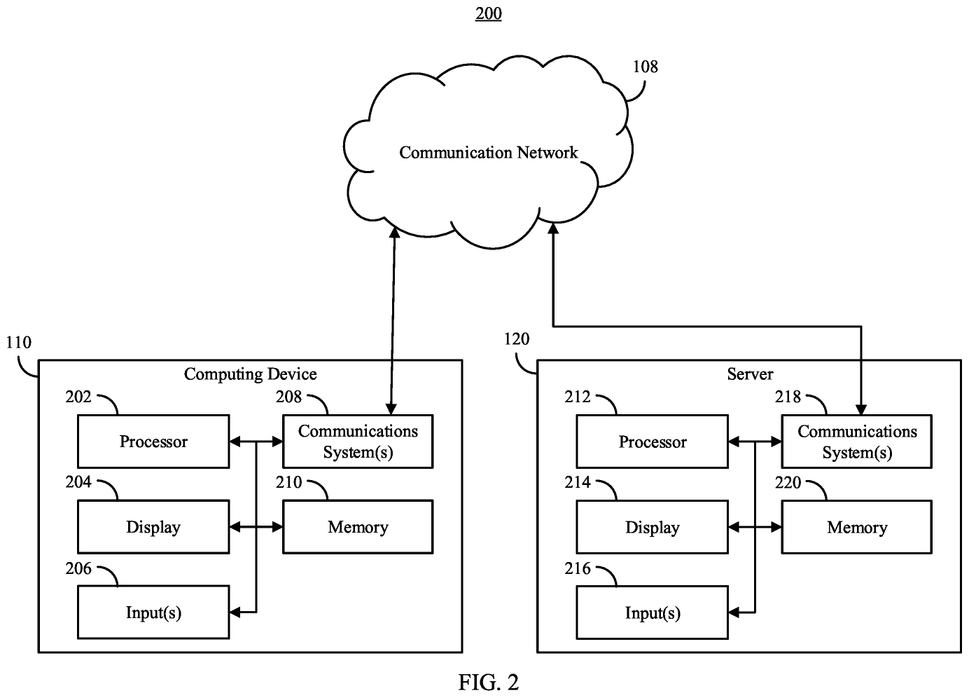

FIG. 2 shows an example 200 of hardware that can be used to implement computing device 110 and/or server 120 in accordance with some embodiments of the disclosed subject matter. As shown in FIG. 2, in some embodiments, computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, a camera, etc.

In some embodiments, communications systems 208 can include any suitable hardware, firmware, and/or software for communicating information over communication network 108 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to perform a visual processing task, to present content using display 204, to communicate with server 120 via communications system(s) 208, etc. Memory 210 can include any suitable volatile memory, non-volatile memory, storage, or any suitable combination thereof. For example, memory 210 can include random access memory (RAM), read-only memory (ROM), electronically-erasable programmable read-only memory (EEPROM), one or more flash drives, one or more hard disks, one or more solid state drives, one or more optical drives, etc. In some embodiments, memory 210 can have encoded thereon a computer program for controlling operation of computing device 110. For example, in such embodiments, processor 202 can execute at least a portion of the computer program to transmit one or more files and a query to server 120, linearize a tabular set of data corresponding to the one or more files, identify an entity from the one or more files, and/or present results related to the entity retrieved from the data table. As another example, processor 202 can execute at least a portion of the computer program to implement the system 100 for retrieving an entity from a data table using semantic search. As yet another example, processor 202 can execute at least a portion of process 700 described below in connection with FIGS. 7-9.

In some embodiments, server 120 can include a processor 212, a display 214, one or more inputs 216, one or more communications systems 218, and/or memory 220. In some embodiments, processor 212 can be any suitable hardware processor or combination of processors, such as a CPU, a GPU, an ASIC, an FPGA, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, a camera, etc.

In some embodiments, communications systems 218 can include any suitable hardware, firmware, and/or software for communicating information over communication network 108 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 110, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 120. For example, in such embodiments, processor 212 can receive one or more files and a query from computing device 110, transmit one or more tabular sets of data corresponding to the one or more files to computing device 110, linearize a tabular set of data corresponding to the one or more files, identify an entity from the one or more files, and/or cause results related to the entity retrieved from the data table to be presented (e.g., by computing device 110). As yet another example, processor 212 can execute at least a portion of process 700 described below in connection with FIGS. 7-9.

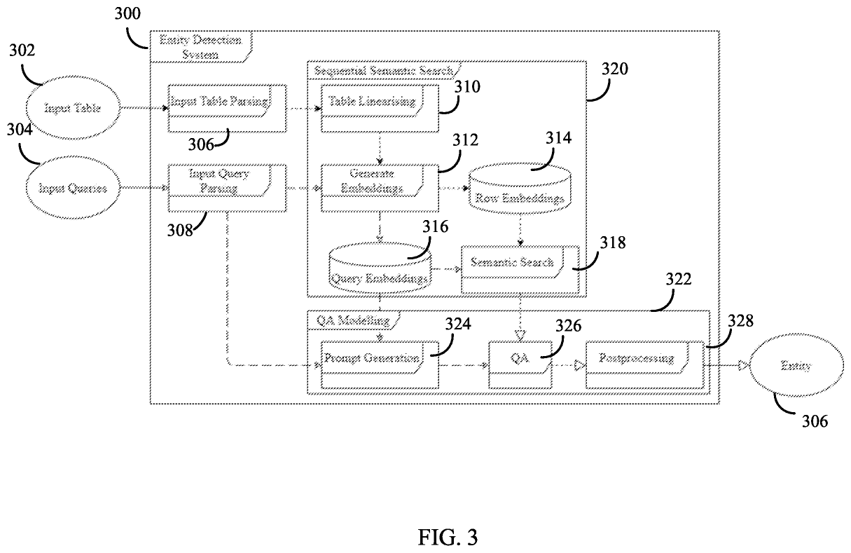

FIGS. 3-6 discussed below illustrate example flowcharts or process diagrams between agents (e.g., functional entities) that can reside at the various elements illustrated in FIG. 1 with respect to system 100. As used herein, the term “mechanism” can encompass hardware, software, firmware, or any suitable combination thereof. With respect to FIGS. 3-6, diagram shapes may be assigned specific meanings. Elliptical shapes may describe a single object, or a collection of objects. Boxes with top-left labels may be system processes (e.g., methods implemented via a processor, such as, for example processor 202, or processor 212). Each system process may contain sub-processes. Cylinders may indicate a collection of objects (e.g., a data structure containing one or more elements). Boxes with central text may indicate system components. Boxes with rounded corners may indicate iterative processes. If a source collection of objects is shown external to a process, then an ellipse with text enclosed within double angled parenthesis may be used to represent each instance of the source collection. Arrows may show the order of processes, as well as a flow of information through each illustrated system or component. Further, arrows of different styles may be used to distinguish between individual process flows.

FIG. 3 shows an example flowchart illustrating a process for retrieving an entity from a data table using semantic search in accordance with some embodiments of the disclosed subject matter. A system 300 (e.g., the system 100 for retrieving an entity from a data table using semantic search) may receive an input table or tabular set of data 302 and input queries 304. The input table 302 may be parsed 306 (e.g., the memory 210 may store computer readable instruction that, when executed by the processor 202, cause the input table to be parsed). The parsing 306 may include parsing the input table 302 into a suitable tabular format for further processing. For example, the input table 302 may be parsed into an HTML string format, JSON format, list format, dictionary format, or any other digital representation of the input table 302. Similarly, the input queries 304 may be parsed 308. The parsing 308 may include parsing one or more of the input queries into a suitable format for further processing. For example, the input queries 304 may be parsed into an HTML string format, JSON format, list format, dictionary format, or any other digital representation of the input queries 304.

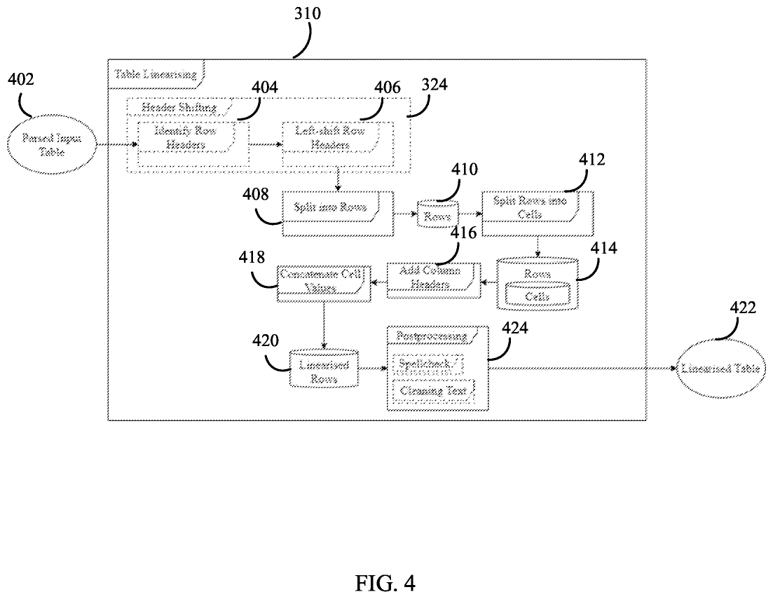

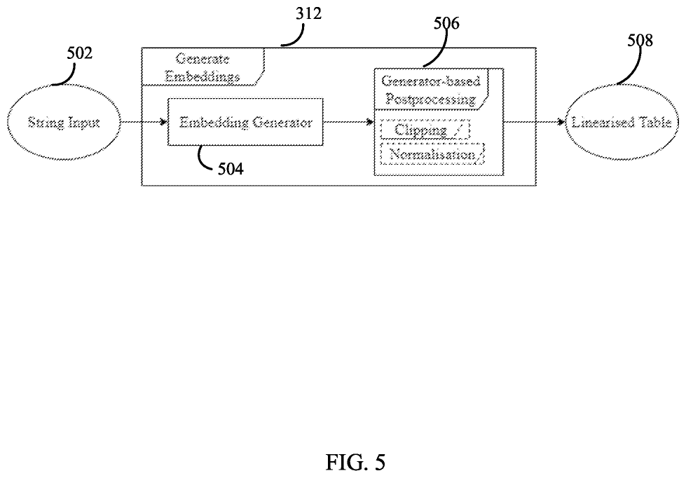

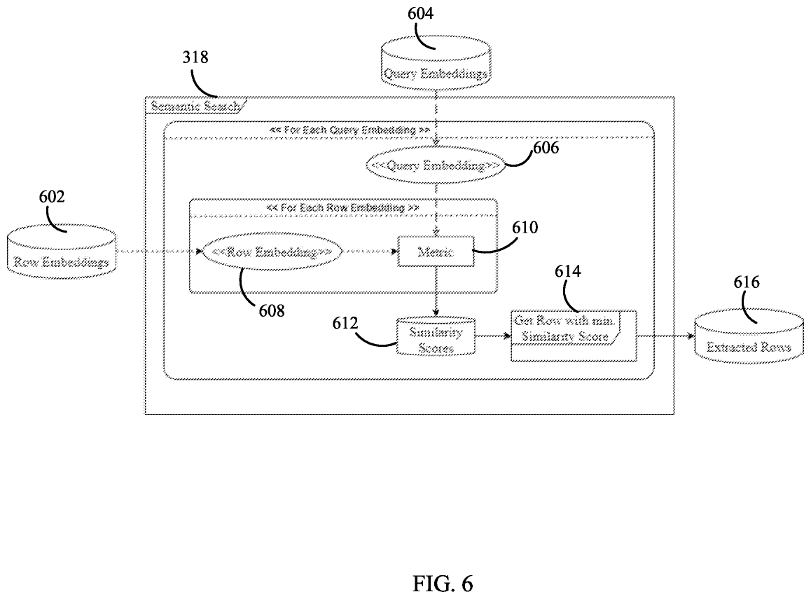

Mechanisms or functions described herein may input the parsed input table (e.g., the input table 302 after being parsed at 306) into a table linearizing mechanism 310 (e.g., the table linearizing mechanism discussed below with respect to FIG. 4). The table linearizing mechanism 310 may then output a linearized table. The linearized table, and the parsed queries may be received by an embeddings generator mechanism 312 (the embeddings generator mechanism 312 may be similar to the embeddings generator mechanism discussed below with respect to FIG. 5). The embeddings generator mechanism 312 may output a data structure containing one or more row embeddings 314, and a data structure containing one or more query embeddings 316. The data structure of one or more row embeddings 314 and the data structure of one or more query embeddings 316 may be received by a semantic search mechanism 318 (the semantic search mechanism 318 may be similar to the semantic search mechanism discussed below with respect to FIG. 6). The semantic search mechanism 318 may output one or more linearized rows. The one or more output linearized rows may be referred to as context.

Generally, the example process of FIG. 3 for retrieving an entity from a data table using semantic search includes a sequential semantic search mechanism 320 and a question answering (QA) modelling mechanism 322. The sequential semantic search mechanism 320 and the QA modelling mechanism 322 may be used in tandem (e.g., the QA modelling mechanism 322 may receive, as inputs, the outputs of the sequential semantic search mechanism 320). Alternatively, the sequential semantic search mechanism 320 and the QA modelling mechanism 322 may be used separately, or in combination with other mechanisms of the present disclosure, or systems, methods, and media known to one of ordinary skill in the art.

Still referring to FIG. 3, the QA modelling mechanism 322 may include one or more subcomponents, such as, for example, a prompt generation mechanism 324, a question answering (QA) mechanism 326, and/or a post-processing mechanism 328. The prompt generation mechanism 324 may receive one or more query embeddings (e.g., the data structure including one or more query embeddings 316), and an input query (e.g., the input query 304). The prompt generation mechanism 324 may generate a prompt (e.g., a string value) based on the one or more query embeddings and the parsed input query.

In some embodiments of the present disclosure, one or more queries (e.g., the input queries 304) may each be converted into a prompt by converting the query into a question with auxiliary text, such as “how much is” or “what is”. The query may be converted to a prompt by adding the auxiliary text that performed best based on a representative set of queries. For example, some embodiments of the present disclosure may be used to analyze financial reports to assist in making business decisions. When a decision maker is searching for specific numbers in the financial reports (e.g., profits, revenue, monthly expenses, etc.), a query may be converted into a question with auxiliary text stating “how much is”. However, other mechanisms that create the query based on information from the query, or tables, or both may also be desirable.

Mechanisms described herein can pass both the prompt (e.g., the output of the prompt generation mechanism 324) and the context (e.g., the output from the semantic search mechanism 318) to the QA mechanism 326. The QA mechanism 326 may use the generated prompts to retrieve the desired entity (e.g., an entity a user wants to retrieve from one or more data tables, such as, the input table 302) from the context provided by the semantic search. The QA mechanism 326 may be a conventional mechanism known to one of ordinary skill in the art, such as RoBERTa or ELECTRA. Additionally, or alternatively, the QA mechanism 326 may be a custom mechanism that receives a prompt and context (e.g., the linearized rows with the highest semantic similarity scores) to retrieve a desired entity from the context.

The QA mechanism 326 may generate one or more outputs such as, for example, a confidence score and/or a string answer. The string answer may be output. Alternatively, in some embodiments of the present disclosure, the string answer may be further processed based on the confidence score and application context. For example, the string answer may be cleaned (e.g., to add characters, to remove characters, to fix spelling). Additionally, or alternatively, the string answer may be voided (e.g., if the confidence score is less than a predetermined confidence threshold, as will be discussed further herein).

FIG. 4 shows a flowchart illustrating an example of the table linearizing process 310 of FIG. 3. The table linearizing process 310 may receive a parsed table 402 (e.g., a parsed table output from the parsing 306 of FIG. 3). The parsed table 402 may be formatted to reduce computational costs during analysis. For example, the parsed table 402 may include row headers and column headers. Some mechanisms described herein may identify 404 a column containing the row headers of the parsed table. Further, in some embodiments of the present disclosure, the column containing the row headers may be shifted 406 to become the left most column of the parsed table, while maintaining the relative ordering of all of the rows, and all of the remaining columns.

The table linearizing process 310 may be useful to generate a linearized version of each row in the parsed table 402. The parsed table may be split 408 into rows 410. The rows 410 may be stored in a data structure (e.g., a dictionary, array, heap, tree, list, queue, stack, or any data structure capable of storing and retrieving its contents, either through iteration or with a digital key). Each of the rows 410 may be split 412 into a respective sequence of cells 414. Each of the cells 414 may contain a value. Each of the values in the cells 414 may be converted into an equivalent or corresponding string representation. Each of the string representations of the values in the cells 414 may be concatenated with the column header value 416 associated with the cell 414. The string representations of the values in the cells 414 concatenated with the column header value 416 associated with the cell 414 may be concatenated 418 together using the same sequence as that of the corresponding cells 414 in the rows 410, thereby forming a corresponding linearized row 420. Alternatively, or additionally, in some embodiments, the string representations of the values in the cells 414 may be concatenated using the same sequence as that of the corresponding cells 414 in the rows 410, thereby forming a corresponding linearized row 420. A list of the linearized rows 420 may form a linearized table 422. The table linearizing process 310 may output the linearized table 422.

The string representations referred to as the linearized rows 420 may be further processed or cleaned 424 to improve results for mechanisms disclosed herein. For example, one or more of the linearized rows 420 can be processed 424 to improve a signal-to-noise ratio of the one or more linearized rows. According to some embodiments disclosed herein, one or more of the linearized rows 420 can have irrelevant characters removed, or spelling errors corrected to improve the signal-to-noise ratio of the one or more linearized rows 420.

FIG. 5 shows a flowchart illustrating an example of the embedding generation process 312 of FIG. 3. The embedding generation process 312 may receive a string input or table of string inputs 502. For example, the embedding generation process 312 may receive the linearized table 422 output by the table linearizing process 310 of FIGS. 3 and 4. The linearized table 422 includes linearized rows (e.g., the linearized rows 420 before or after going through the processing 424). Additionally, or alternatively, in some embodiments of the present disclosure, the embedding generation process 312 may receive one or more linearized rows (e.g., the linearized rows 420 before or after going through the processing 424). An embedding generator 504 may create a dimensional numeric representation of each of the linearized rows 420, and the queries 304. The dimensional numeric representation of each of the linearized rows 420, and the queries 304 may be an embedding vector or vector. Further, the vectors may, collectively, form a set of vectors. The vectors may be output (e.g., in a table 508, or another data structure containing the vectors).

The embedding generator 504 may create dimensional numeric representations of each of the linearized rows 420, and the queries 304, using known techniques. In some embodiments of the present disclosure, the embedding generator 504 may be a pre-trained Universal Sentence Encoder that can used to generate the embedding vectors. The Universal Sentence Encoder is a neural network model that encodes text into high dimensional vectors that can be used for downstream tasks. The neural network model is trained and optimized for greater-than-word length text, such as, for example, sentences, phrases or short paragraphs. The neural network model is trained on a variety of data sources and a variety of tasks with the aim of dynamically accommodating a wide variety of natural language understanding tasks. An input to the Universal Sentence Encoder may be variable length English text, and the output may be a 512 dimensional vector.

Mechanisms disclosed herein may afford flexibility and robustness by allowing a variety of embedding generating methods to be utilized depending on the industrially applicable context of mechanisms disclosed herein. Additionally or alternatively to the Universal Sentence Encoder, other methods for generating the embedding vectors can be used. For example, BERT, CountVectorizer, ELMo, or other known mechanisms for generating embedding vectors can be used in combination with mechanisms disclosed herein.

The generated embedding vectors can be post-processed 506 to improve efficiency and accuracy of mechanisms disclosed herein. For example, in some embodiments of the present disclosure, one or more embedding generated by the embedding generator 504 may be normalized (e.g., if the embeddings are vectors, the vectors may maintain their directions and be converted to unit vectors), such that a length of each of the one or more embedding can be ignored. Additionally, or alternatively, in some embodiments of the present disclosure, one or more embeddings generated by the embedding generator 504 may be clipped (e.g., if one of the embeddings is a vector with a magnitude greater than 2, then the magnitude of the vector may be set to 2).

FIG. 6 shows an example flowchart illustrating the semantic search process 318 of FIG. 3. The semantic search process 318 may receive as input, a data structure of row embeddings 602 (e.g., one or more vectors corresponding to the linearized rows), and a data structure of query embeddings 604 (e.g., one or more vectors corresponding to the input queries of FIG. 3). For each query embedding 606 in the data structure of query embeddings 604, mechanisms described herein may calculate, for each row embedding 608 in the data structure of row embeddings, a metric or similarity metric 610 corresponding to each relationship between the query embeddings 604 and the row embeddings 602.

The metric 610 may be a measure of similarity between two points in an embedding space (e.g., between a query embedding or query vector and a row embedding or row vector). In some embodiments, the metric 610 may be calculated using Cosine Similarity between a row vector and a query vector. Additionally or alternatively, in some embodiments, the metric 610 may be calculated using the inverse Euclidean distance between a row vector and a query vector. In some embodiments of the present disclosure, Cosine Similarity or Euclidean distance may be used to generate distance measurements between one or more vectors (e.g., a row vector, or a query vector) in an embedded space. However, in other embodiments of the present disclosure, any method that generates a numeric representation of the similarity of a distance, or inverse distance, between a pair of points in the embedding space can be used to calculate the metric 610.

In accordance with some embodiments of the present disclosure, the metric 610 may be used to calculate a similarity score or confidence score 612 between each row embedding 608 and each query embedding 606. Mechanisms disclosed herein may analyze the calculated similarity scores 612 to identify 614 which linearized row (e.g., of the linearized rows 420) has the greatest similarity to a given query. The linearized row (e.g., of the linearized rows 420) with the greatest similarity to an input query (e.g., the input query 304) may be referred to as an extracted row or context 616. The example process of FIG. 6 may store one or more extracted rows 616 in a data structure stored in memory (e.g., memory 210, or memory 220).

FIG. 7 shows an example of a process 700 for retrieving an entity from a data table using semantic search in accordance with some embodiments of the disclosed subject matter. The process 700 may be used by a decision maker (e.g., manager, supervisor, executive), or someone working on behalf of a decision maker, in an organization to retrieve desired information from a plethora of files (e.g., financial reports). For example, the decision maker, or someone working on behalf of the decision maker, may use a computing device (e.g., a personal computer or other computing device, such as, for example, computing device 210) to carry out all or part of process 700. Additionally, or alternatively, the decision maker may provide inputs to a communication network (e.g., communication network 108), such that all or part of process 700 can be carried out on a remote server (e.g., server 120).

At step 702, process 700 can receive one or more files, and a query. For example, a computing device (e.g., computing device 110) may receive the one or more files, and the query through one or more inputs (e.g., input 206), and store the one or more files and the query in memory (e.g., memory 210). Additionally, or alternatively, a server (e.g., server 120) may receive the one or more files and the query through one or more inputs (e.g., inputs 216), and store the one or more files and the query in memory (e.g., memory 220).

At step 704, process 700 can identify a tabular set of data from the one or more files using visual processing of the one or more files. For example, if the one or more files are physical files, then a computing device (e.g., computing device 110) may include, or be used in connection with, a visual processing device (e.g., scanner, optical lens, camera). A processor (e.g., processor 202) on the computing device may execute instructions such that the computing device may identify the tabular set of data one the one or more files by using the visual processing device. Additionally, or alternatively, if the one or more files are digital files, then a computing device or server may execute instructions (via a processor) to perform an optical character recognition process on the digital file to identify the tabular set of data.

At step 706, process 700 can linearize the tabular set of data corresponding to the one or more files. For example, a computing device (e.g., computing device 110) can store computer readable instructions in memory (e.g., memory 210) that, when executed by a processor (e.g., processor 202), cause the computing device to linearize the tabular set of data. Additionally, or alternatively, a server (e.g., server 120) can store computer readable instructions in memory (e.g., memory 220) that, when executed by a processor (e.g., processor 212), cause the server to linearize the tabular set of data. In some embodiments of the disclosed subject matter, the tabular set of data can be cleaned prior to being linearized. The tabular set of data may be pre-processed (e.g., by the processor 202 or 212 executing instructions stored in memory 210 or 220) to remove unnecessary notations (e.g., foreign number notations, or scientific notation). Further, the tabular set of data may be preprocessed to remove non-alphanumeric characters. This may be particular helpful, for example, if the one or more files are financial documents that include symbols, such as, for example currency symbols (e.g., dollar signs, cents signs, pound signs, yen signs, etc.), units (e.g., distance, volume, time, temperature, mass, etc.), or other symbols (e.g., percent signs, Greek letters, etc.)

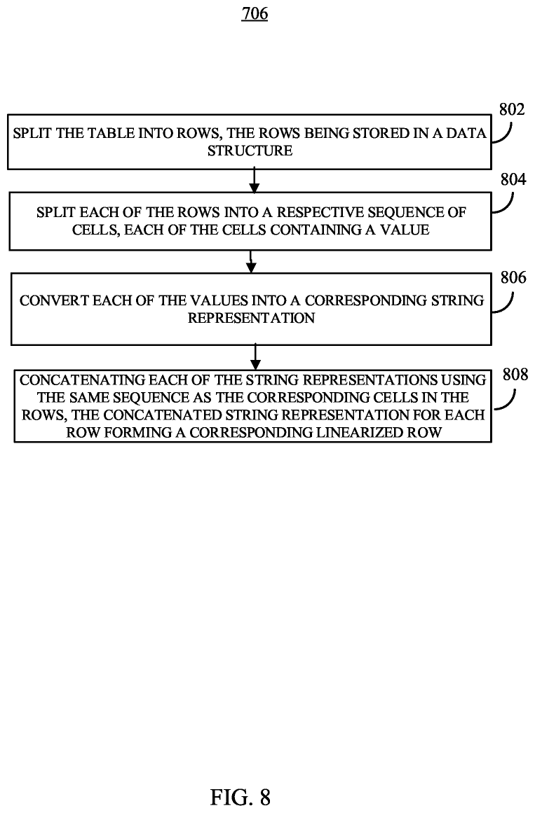

At step 708, process 700 can generate a first set of vectors based on linearized rows (e.g., the linearized rows discussed with respect to FIG. 8 below, and/or the linearized rows 420 discussed with respect to FIG. 4). The process 700 can generate the first set of vectors by inputting (via processor 202 or 212) the linearized rows into an embedding generator (e.g., embedding generator 504) stored in memory (e.g., memory 210 or 220), and receiving, from the embedding generator, the first set of vectors. The linearized rows may be input into the embedding generator by transferring data in memory from a first location to a second location (e.g., from a first location in memory 210 to a second location in memory 210, from a first location in memory 220 to a second location in memory 220, from a first location in memory 210 to a second location in memory 220, or vice versa). Further, the first set of vectors may be received from the embedding generator by storing data corresponding to the first set of vectors in memory (e.g., memory 210 or 220).

At step 710, process 700 can generate a query vector for the query. The process 700 can generate the query vector by inputting (via processor 202 or 212) the query (e.g., query 304) into an embedding generator (e.g., embedding generator 504) stored in memory (e.g., memory 210 or 220), and receiving, from the embedding generator, the query vector. The query vector may be input into the embedding generator by transferring data in memory from a first location to a second location (e.g., from a first location in memory 210 to a second location in memory 210, from a first location in memory 220 to a second location in memory 220, from a first location in memory 210 to a second location in memory 220, or vice versa). Further, the query vector may be received from the embedding generator by storing data corresponding to the query vector in memory (e.g., memory 210 or 220).

Further, at step 712, process 700 can output one or more of the linearized rows based on the first set of vectors and the query vectors. The one more linearized rows may be output to a QA modelling mechanism (e.g., the QA modelling mechanism discussed above with respect to FIG. 3). The one or more linearized rows may be output, for example, by transferring data from a first location in memory (e.g., memory 210 or 220) to a second location in memory (e.g., memory 210 or 220). Additionally, or alternatively, the one or more linearized rows may be output by, for example, transferring data from a computing device (e.g., computing device 110) to a server (e.g., server 120) through a communication network (e.g., communication network 108), or vice versa.

At step 714, process 700 can provide one or more prompts (e.g., “how much is . . . ?” or “what is . . . ?”) to extract a desired entity from the one or more output-linearized rows. The one or more prompts may be generated in a similar fashion as discussed above with respect to the prompt generation mechanism of FIG. 3. The one or more prompts can be presented to a user (e.g., on display 204 or 214) to be selected by a user via inputs (e.g., inputs 206 or 216). Additionally, or alternatively, the prompts can be predetermined based on a given industrial applicability of some embodiments disclosed herein, and stored in memory (e.g., memory 210 or 220). If the prompts are predetermined and stored in memory, then a processor (e.g., processor 202 or 212) may execute instructions to extract the one or more output-linearized rows based on the prompts stored in memory.

At step 716, process 700 can calculate a confidence score based on the one or more output linearized rows and the one or more prompts. The confidence score may be calculated using similar techniques to the similarity score discussed above with respect to FIG. 6. Additionally, or alternatively, the confidence score may be an indication of how valid the output linearized rows are based on the one or more prompts. The confidence score can be calculated via the combination of a processor and memory (e.g., processor 202 or 212, and memory 210 or 220).

FIG. 8 shows an example of a process for linearizing a tabular set of data (e.g., a sub-process of step 706 of process 700) in accordance with some embodiments of the disclosed subject matter.

At step 802, step 706 of process 700 can split the table into rows. The rows can be stored in a data structure. For example, in some embodiments, a processor (e.g., processor 202 or 212) may store partitions of the table into separate locations in memory (e.g., memory 210 or 220) corresponding to the rows. At step 804, step 706 of process 700 can split each of the rows into a respective sequence of cells. For example, in some embodiments, a processor (e.g., a processor 202 or 212) may store partitions of the rows into separate location in memory (e.g., memory 210 or 220) corresponding to the cells. Each of the cells can contain a value (e.g., a data value stored in the location of the cell in memory 210 or 220). At step 806, step 706 of process 700 can convert (via processor 202 or 212) each of the values into a corresponding string representation. The corresponding string representation may be stored in memory (e.g., memory 210 or 220). Further, at step 808, step 706 of process 700 can concatenate (e.g., via processor 202 or 212) each of the string representations using the same sequence as the corresponding cells in the rows. The concatenated string representations for each row can form a corresponding linearized row. The corresponding linearized rows can be stored in memory (e.g., memory 210 or 220).

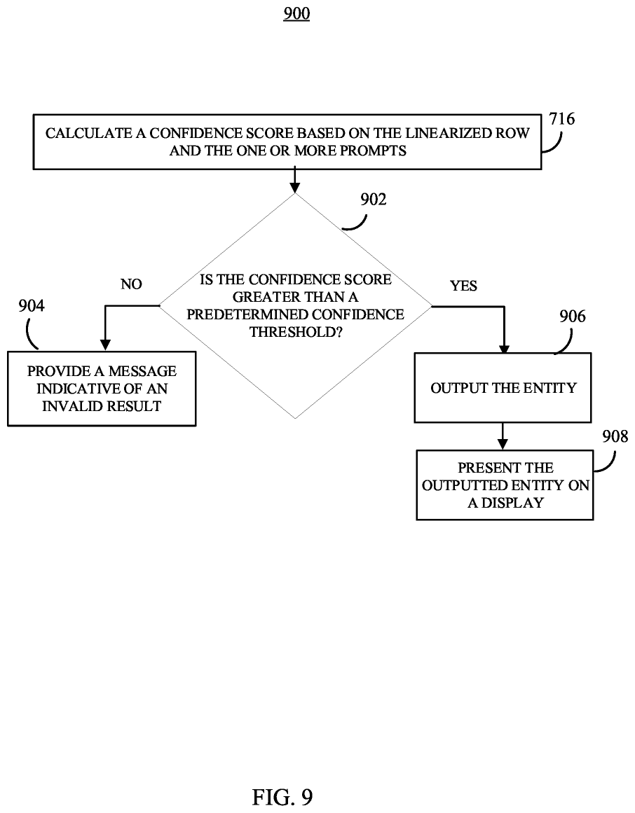

FIG. 9 shows an example of a process 900 for calculating a confidence score in accordance with some embodiments of the disclosed subject matter.

Process 900 may be a continuation of process 700 from step 716. At step 902, process 900 may evaluate (e.g., via processor 202 or 212) if the confidence score is greater than a predetermined confidence threshold. If the confidence score is not greater than the predetermined confidence threshold, then at step 904, process 900 may provide (e.g., via processor 202 or 212) a message indicative of an invalid result. However, if the confidence score is greater than the predetermined threshold, then at step 906, process 900 may output (e.g., via processor 202 or 212) the entity. Further, at step 908, process 900 may present the outputted entity on a display (e.g., display 204 or 214).

The predetermined confidence threshold may be a value set by a user depending on the industrial application of mechanisms disclosed herein. For example, in some industries, it may be beneficial to receive information (e.g., the entity) from a data table, even if the data is relatively inaccurate. In other industries, it may only be beneficial to receive information (e.g., the entity) from a data table if embodiments of the present disclosure are highly confident that the information is accurate. Providing a comparison between the predetermined confidence threshold and the confidence score provides flexibility of mechanisms disclosed herein for a variety of use cases.

Generally, systems, methods, and media of the present disclosure may linearize a tabular set of data to create string representations referred to as linearized rows. Embeddings or vectors may be generated based on the linearized rows. Further, a similarity metric may be used to identify relationships between the embeddings or vectors to output one or more desired entities from the tabular set of data.

Some embodiments of the present disclosure may be beneficial to reduce computational costs over conventional methods of retrieving entities from a data table using semantic search. Further embodiments of the present disclosure may increase protection of private or confidential information by applying a zero-shot learning method (e.g., large amounts of data are not required to train a model). Still further, embodiments of the present disclosure may provide accurate results over known techniques (e.g., methods that require training a machine-learning model to apply semantic searching techniques).

In some embodiments, any suitable computer readable media can be used for storing instructions for performing the functions and/or processes described herein. For example, in some embodiments, computer readable media can be non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media.

The above-described aspects of the processes of FIGS. 3-9 can be executed or performed in any order or sequence not limited to the order and sequence shown and described in the figures. Also, some of the above aspects of the processes of FIGS. 3-9 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method of retrieving an entity from a data table, the method comprising:
receiving one or more files, and a query;
linearizing a tabular set of data corresponding to the one or more files, wherein the linearizing comprises:
splitting the tabular set of data into rows, the rows being stored in a data structure;
splitting each of the rows into a respective sequence of cells, each of the cells containing a value;
converting each of the values into a corresponding string representation; and
concatenating each of the string representations using the same sequence as that of the corresponding cells in the rows, the concatenated string representations for each row forming a corresponding linearized row;
generating a first set of vectors based on the linearized rows;
generating a query vector for the query; and
outputting a result based on the first set of vectors and the query vector.

2. The method of claim 1, wherein the tabular set of data is identified using visual processing of the one or more files.

3. The method of claim 1, wherein the result is one or more of the linearized rows based on a distance between the query vector and one or more vectors of the first set of vectors.

4. The method of claim 3, further comprising:
providing one or more prompts to identify the entity from the result;
calculating a confidence score based on the one or more output linearized rows and the one or more prompts;
comparing the confidence score to a confidence threshold; and
if the confidence score is greater than the confidence threshold, outputting the entity.

5. The method of claim 3, wherein generating a first set of vectors based on the linearized rows comprises:
inputting the linearized rows into a generator; and
receiving, from the generator, a first set of vectors based on the linearized rows.

6. The method of claim 1, wherein the query is a plurality of queries, wherein the query vector is one of a plurality of query vectors, and wherein the result is based on the first set of vectors and the plurality of query vectors.

7. The method of claim 1, wherein the one or more files are financial reports.

8. The method of claim 1, further comprising:
preprocessing the tabular set of data to remove non-alphanumeric characters, prior to linearizing the tabular set of data.

9. A non-transitory computer readable medium, storing programmable instructions that, when executed by a computing system, cause the computing system to:
receive one or more files, and a query;
linearize a tabular set of data corresponding to the one or more files, wherein the linearizing comprises:
splitting the tabular set of data into rows, the rows being stored in a data structure;
splitting each of the rows into a respective sequence of cells, each of the cells containing a value;
converting each of the values into a corresponding string representation; and
concatenating each of the string representations using the same sequence as that of the corresponding cells in the rows, the concatenated string representations for each row forming a corresponding linearized row;
generate a first set of vectors based on the linearized rows;
generate a query vector for the query; and
identify an entity from the one or more files based on the first set of vectors and the query vector.

10. The non-transitory computer readable medium of claim 9, wherein the tabular set of data is identified using visual processing of the one or more files.

11. The non-transitory computer readable medium of claim 9, wherein the one or more files are financial reports.

12. The non-transitory computer readable medium of claim 9, wherein the tabular set of data is, prior to being linearized, preprocessed to remove non-alphanumeric characters.

13. The non-transitory computer readable medium of claim 9, wherein the programmable instructions further cause the computing system to: output a result based on the first set of vectors and the query vector.

14. The non-transitory computer readable medium of claim 13, wherein the result is one or more of the linearized rows based on a distance between the query vector and one or more vectors of the first set of vectors.

15. The non-transitory computer readable medium of claim 14, wherein the query is one of a plurality of queries, wherein the query vector is one of a plurality of query vectors, and wherein the result is based on the first set of vectors and the plurality of query vectors.

16. The non-transitory computer readable medium of claim 14, wherein the programmable instructions further cause the computing system to:
provide one or more prompts to identify the entity from the one or more output linearized rows;
calculate a confidence score based on the one or more output linearized rows and the one or more prompts;
compare the confidence score to a confidence threshold; and
if the confidence score is not greater than the confidence threshold, providing a message indicative of an invalid result.

17. The non-transitory computer readable medium of claim 14, wherein the programmable instructions further cause the computing system to:
provide one or more prompts to identify the entity from the one or more output linearized rows;
calculate a confidence score based on the one or more output linearized rows and the one or more prompts;
compare the confidence score to a confidence threshold; and
if the confidence score is greater than the confidence threshold, output the entity.

18. The non-transitory computer readable medium of claim 17, wherein to generate the query vector, the programmable instructions cause the computing system to:
input the query into a generator; and
receive, from the generator, the query vector.

19. A system for retrieving an entity from a data table, the system comprising:
a remote server,
a communications connection between the remote server and a computing device;
at least one processor coupled to the communication connection,
a memory device having stored thereon a set of computer readable instruction which, when executed by the at least one process, cause the at least one processor to:
receive one or more files, and a query;
linearize a tabular set of data corresponding to the one or more files, wherein the linearizing comprises:
splitting the table into rows, the rows being stored in a data structure;
splitting each of the rows into a respective sequence of cells, each of the cells containing a value;
converting each of the values into a corresponding string representation; and
concatenating each of the string representations using the same sequence as that of the corresponding cells in the rows, the concatenated string representations for each row forming a corresponding linearized row;
generate a first set of vectors based on the linearized rows;
generate a query vector for the query; and
output a result based on the first set of vectors and the query vector.

20. The system of claim 19, wherein the query is a plurality of queries, wherein the query vector is one of a plurality of query vectors, and wherein the result is based on the first set of vectors and the plurality of query vectors.
